(19) United States
(12) Patent Application Publication
(10) Pub. No.: US 2017/0190150 A1
(43) Pub. Date: Jul. 6, 2017

(54) Laminate of a Metal Sheet and an Adhesive Layer Bonded Thereto

(71) Applicant: GTM-Advanced Products B.V., s-Gravenhage (NL)

(72) Inventor: Jan Willem Gunnink, Nieuwerkerk aan den IJsel (NL)

(73) Assignee: GTM-Advanced Products B.V., s-Gravehage (NL)

(21) Appl. No.: 15/314,213

(22) PCT Filed: May 22, 2015
(86) PCT No.: PCT/NL2015/050372

§ 371 Date: Nov. 28, 2016

(30) Foreign Application Priority Data
May 26, 2014 (NL) 2012889

(51) Int. Cl. B32B 15/14; B32B 15/20; B32B 15/092; B32B 5/02; B32B 15/08

(52) U.S. Cl. CPC B32B 15/14; B32B 5/02; B32B 15/08; B32B 15/092; B32B 15/20

(57) ABSTRACT

Disclosed is a laminate including a first metal sheet and an adhesive layer bonded to the first metal sheet, in which the following relationship applies: 1≦(Eₘₑₜₐₗ*tₘₑₜₐₗ)/(E_{adh}*t_{adh})≦15 (1), where Eₘₑₜₐₗ=tensile Young's modulus of the first metal sheet, tₘₑₜₐₗ=thickness of the first metal sheet, E_{adh}=tensile Young's modulus of the adhesive layer, and t=thickness of the adhesive layer. The adhesive layer may include reinforcing fibers. The laminate may be used for providing a fatigue resistant structure, such as an aerospace structure, and shows a high crack growth resistance, in particular near edges of the structure.

### FIELD OF THE INVENTION

The present invention relates to a laminate comprising at least one metal sheet bonded to an adhesive layer. The invention more particularly relates to a laminate comprising metal sheets that are mutually bonded by an adhesive layer. Even more particularly, the invention relates to a fiber-metal laminate comprising metal sheets that are mutually bonded by a fiber-reinforced composite layer.

The invention further relates to the use of such a laminate for providing a fatigue resistant structure, particularly an aerospace structure. Aerospace structures in which the laminate may be used comprise but are not limited to a fuselage structure, a tail plane structure, or a wing structure.

### BACKGROUND OF THE INVENTION

The behavior of engineering structures under load is determined by many design parameters, and defining the optimum material for a specific application is often a tedious task and moreover has to deal with conflicting requirements. Among the commonly used engineering materials are metals, like steel alloys, titanium alloys, aluminum alloys; fiber-reinforced composites, like glass fiber composites, carbon fiber composites, and aramid composites; and hybrid materials, further defined below.

Fiber-reinforced composites offer considerable weight advantage over other preferred materials, such as metals. Generally, the weight savings are obtained at the sacrifice of other important material properties such as ductility, toughness, bearing strength, conductivity and cold forming capability. To overcome these deficiencies, new hybrid materials called fiber-metal laminates have been developed to combine the best attributes of metal and composites.

Fiber-metal laminates (also referred to as FML), such as those described in U.S. Pat. No. 4,500,589 for instance are obtained by stacking alternating sheets of metal (most preferably aluminum) and fiber-reinforced prepregs, and curing the stack under heat and pressure. These materials are increasingly used in industries such as the transportation industry, for example in ships, cars, trains, aircraft and spacecraft. They can be used as sheets and/or a reinforcing element and/or as a stiffener for (body) structures of these transports, like for aircraft for wings, fuselage and tail panels and/or other skin panels and structural elements of aircraft.

US 2011/246370 A1 and U.S. Pat. No. 4,489,123 A disclose fiber-metal laminates that use S2 glass or aramid fiber composite layers and aluminum 2024-T3 alloy sheets. These documents do not disclose laminates with specific combinations of metal sheet and fiber composite layer thicknesses that would yield a significantly improved fatigue behavior compared to other laminates.

Although fiber-metal laminates may provide improved resistance to fatigue (in particular crack propagation) over metal alloys, in particular aluminum alloys, their behavior in a structure is still open for improvement, in particular in structures that are subject to dynamic loadings. An important characteristic in this respect is resistance to crack growth. It would be highly desirable if the right metal sheets and fiber-reinforced composite layers could be identified in terms of their properties in view of achieving the lowest crack growth rate of the corresponding fiber-metal laminate.

It is an object of the invention to provide a laminate of metal sheets mutually bonded by an adhesive layer, in particular a fiber-metal laminate, having an optimal structural response in dynamic loading, in particular with a relatively low crack growth rate.

### SUMMARY OF THE INVENTION

According to one aspect of the present invention there is provided a laminate comprising metal sheets that are mutually bonded by an adhesive layer having a range of adhesive layer and metal properties that yield an optimal structural response.

The present invention provides a laminate comprising a first metal sheet and an adhesive layer bonded to the first metal sheet, in which laminate the following relation applies:

1≦(Eₘₑₜₐₗ*tₘₑₜₐₗ)/(E_{adh}*t_{adh})≦15 (1)
wherein

Eₘₑₜₐₗ=tensile Young's modulus of the first metal sheet

tₘₑₜₐₗ=thickness of the first metal sheet

E_{adh}=tensile Young's modulus of the adhesive layer

t_{adh}=thickness of the adhesive layer

The relation (1) defines the optimum properties of an adhesive layer and the properties of the first metal sheet adjacent to said adhesive layer in terms of fatigue resistance of the laminate. Combinations of first metal sheet thickness and stiffness, and adhesive layer thickness and stiffness that satisfy relation (1) yield a maximum number of fatigue life cycles in a fatigue test. The property E*t of relation (1) equals the product of the tensile Young's modulus and the thickness of a material and is also referred to as the extensional stiffness (dimension Pa.m or N/m).

The terminology ‘first metal sheet’ is used to denote that the laminate may comprise more than one metal sheet and that the first metal sheet is one of the metal sheets. A ‘first metal sheet’ does not refer to a particular position of the metal sheet in the laminate, for instance the first metal sheet is not necessarily the outermost metal layer. The thicknesses tₘₑₜₐₗ and t_{adh} in particular are determined in the laminate as cured.

The thickness of a particular layer or sheet generally refers to a constant thickness unless indicated otherwise. The thickness of the first metal sheet may in principle be chosen within a large range. In useful embodiments of the invention, a laminate is provided wherein the first metal sheet has a thickness tₘₑₜₐₗ of larger than 0.50 mm (0.02″), more preferably of larger than 0.55 mm (0.22″), even more preferably of larger than 0.6 mm (0.024″), even more preferably of larger than 0.8 mm (0.32″), and most preferably of larger than 1 mm (0.04″).

Another embodiment of the invention relates to a laminate comprising a second metal sheet bonded to the adhesive layer and having a thickness of ≦tₘₑₜₐₗ. Such a laminate of metal sheets mutually bonded to an adhesive layer, comprises a first metal sheet with a thickness tₘₑₜₐₗ, a second metal sheet with a thickness ≦tₘₑₜₐₗ,and in between and bonded to the first and second metal sheets an adhesive layer. In accordance with the invention, relation (1) applies for the combination of the first metal sheet and the adhesive layer. In a broadest aspect of the invention, the properties of the second metal layer are immaterial. When the thickness of the second metal layer is equal to tₘₑₜₐₗ and the first and second metal sheet use the same metal alloy, the properties of the first or second layer may be used in relation (1). When the thickness of the second metal layer is equal to tₘₑₜₐₗ and the first and second metal sheet use a different metal alloy, the properties of the stiffer of the first and second layers are used in relation (1).

Preferred embodiments of the invention relate to a laminate wherein 1.5≦(Eₘₑₜₐₗ*tₘₑₜₐₗ) (E_{adh}*t_{adh})≦15, more preferably 3.5≦(Eₘₑₜₐₗ*tₘₑₜₐₗ)/(E_{adh}*t_{adh})≦15, even more preferably 3.5≦(Eₘₑₜₐₗ*tₘₑₜₐₗ)/(E_{adh}*t_{adh})≦12.5, even more preferably 4.25≦(Eₘₑₜₐₗ*tₘₑₜₐₗ)/(E_{adh}*t_{adh})≦13.5, even more preferably 5.0≦(Eₘₑₜₐₗ*tₘₑₜₐₗ)/(E_{adh}*t_{adh})≦13.5, even more preferably 5.5≦(Eₘₑₜₐₗ*tₘₑₜₐₗ)/(E_{adh}*t_{adh})≦12.5, and most preferably 5.5≦(Eₘₑₜₐₗ*tₘₑₜₐₗ)/(E_{adh}*t_{adh})≦10.

The adhesive layer or layers of the laminate are in preferred embodiments provided with reinforcing fibers. According to an embodiment of the invention, a laminate is provided wherein the adhesive layer comprises reinforcing fibers to form a fiber-metal laminate, and
E_{adh}=tensile Young's modulus of the fiber reinforced adhesive layer in a direction of maximum stiffness
t_{adh}=thickness of the fiber reinforced adhesive layer

The reinforcing fibers may be oriented in one direction or in several different directions, depending on the loading conditions of the laminate or structure comprising the laminate. The tensile Young's modulus E_{adh} may therefor differ with the direction of loading and E_{adh} in relation (1) relates to the tensile Young's modulus of the fiber reinforced adhesive layer in a direction of maximum stiffness.

Preferred reinforcing fibers comprise continuous fibers made of glass, aromatic polyamides (“aramids”) and copolymers, carbon, and/or polymeric fibers such as PBO for instance. Preferred glass fibers include S-2, S-3 and/or R-glass fibers, as well as carbonized silicate glass fibers, although E-glass fibers are also suitable. Particularly preferred fibers comprise high strength glass fibers having a tensile Young's modulus of at least 80 GPa, preferably of at least 85 GPa, and most preferably of at least 90 GPa.

The reinforcing fibers may be provided in prepregs, an intermediate product of reinforcing fibers embedded in a partly cured thermosetting resin or in a thermoplastic polymer. Typically fiber volume fractions range from 15 to 75%, more preferably from 25 to 75%, even more preferably from 20 to 65%, and most preferably from 30 to 65% of the total volume of adhesive and reinforcing fiber in the adhesive layers. The effective fiber volume fraction in an adhesive layer may be lowered by adding plain adhesive layers to reinforced adhesive layers.

According to an embodiment of the invention, a laminate is provided comprising a fiber-reinforced adhesive layer with at least two different fibers, and/or comprising fiber-reinforced composite layers that differ in fiber. In the present application, fiber-reinforced adhesive layers are also referred to as (fiber-reinforced) composite layers.

The adhesive layers preferably comprise synthetic polymers. Suitable examples of thermosetting polymers include epoxy resins, unsaturated polyester resins, vinyl ester resins, and phenolic resins. Suitable thermoplastic polymers include polyarylates (PAR), polysulphones (PSO), polyether sulphones (PES), polyether imides (PEI), polyphenylene ethers (PEE), polyphenylene sulphide (PPS), polyamide-4,6, polyketone sulphide (PKS), polyether ketones (PEK), polyether ether ketone (PEEK), polyether ketoneketone (PEKK), and others. The laminate may be provided with additional adhesive in certain areas, apart from the adhesive present in the adhesive layers.

A laminate satisfying relation (1) shows optimal properties, by which is meant that a lower crack growth rate is generally achieved than with laminates that do not satisfy relation (1). This teaching has not been disclosed before and makes a laminate in accordance with the invention particularly useful in providing a fatigue resistant structure.

According to a further aspect of the invention a laminate is provided comprising N metal sheets having a thickness >tₘₑₜₐₗ, and M metal sheets having a thickness ≦tₘₑₜₐₗ, wherein N ≧2 and M ≧1. The metal sheets are mutually bonded through intermittent adhesive layers, preferably reinforced with reinforcing fibers. The number of M metal sheets having a thickness ≦tₘₑₜₐₗ may all be bonded to a first metal sheet having a thickness tₘₑₜₐₗ. In another embodiment of the invention however, a laminate is provided comprising P second metal sheets (directly bonded to a first metal sheet), wherein P ≧1 and <M.

Preferred laminates comprise one or both outer layers of metal, or one or both outer layers of a fiber-reinforced composite. Particularly preferred is a laminate comprising at least one and more preferably two first metal sheets as outer layer.

The thickness of the first and optionally second metal sheet may be varied within a large range, as long as relation (1) is satisfied. In a useful embodiment of the invention a laminate is provided wherein the thickness of the first metal sheet is more than 1.5 mm (0.06″). In another embodiment, a laminate is provided wherein the thickness of the second metal sheet is less than 0.8 mm (0.032″), preferably less than 0.6 mm (0.024″), most preferably less than 0.5 mm (0.02″). Any combination of these embodiments is particularly preferred.

Although the thickness of the metal sheets in the (fiber-metal) laminate of the invention may all be the same, apart from the first metal sheet thickness, a laminate in accordance with an embodiment of the invention comprises metal sheets of different thickness. Although the thickness of adhesive layers in the (fiber-metal) laminate of the invention may also be the same, a laminate in accordance with an embodiment of the invention may also comprise adhesive layers of different thickness.

A useful embodiment of the invention provides a laminate wherein the first and/or second metal sheet has a variable thickness, and the thickness tₘₑₜₐₗ of the first metal sheet used in relation (1) corresponds to the largest thickness of the first metal sheet. It is to be understood that the area of largest thickness extends over a major part of the laminate's area, preferably over more than 80% of the laminate's area, more preferably over more than 85%, and most preferably over more than 90% of the laminate's area. The thickness of the first and/or second metal sheet may be varied instantaneously at some position (providing a sudden step in thickness) or may be varied continuously to obtain a gradual variation in thickness (providing a tapering thickness). The thickness may for instance be decreased by milling away some material or by any other means known in the art. A variation in thickness typically occurs at edges of the laminate.

A further embodiment of the invention provides a (fiber-metal) laminate, comprising metal sheets of different metal alloys. In accordance with another embodiment however, a fiber-metal laminate may be provided that comprises metal sheets of the same metal alloy. Although the metal of the metal sheets in the laminate may be chosen at will, in still another aspect of the invention, a laminate is provided wherein the metal of the metal sheets is selected from steel alloys, aluminum alloys, and titanium alloys, whereby titanium alloys are particularly useful. Metal sheets of an aluminum alloy are particularly preferred.

Apart from the first and second metal sheets, a laminate according to the invention may in an embodiment comprise metal sheets of which the thickness preferably ranges between 0.2 mm (0.008″) and 4 mm (0.16″), more preferably between 0.3 mm (0.012″) and 2 mm (0.079″), and most preferably between 0.4 mm (0.016″) and 1.5 mm (0.06″).

Another aspect of the invention provides a laminate having an edge and a laminate thickness that is reduced in an edge area of the laminate towards the edge by ending the first metal sheet at a first distance from the laminate edge, and/or by ending the second metal sheet at a second distance from the laminate edge, and/or by ending the adhesive layer at a third distance from the edge. The laminate thickness is defined as the sum of all the thicknesses of stacked first, second and other metal sheets, and (fiber-reinforced) adhesive layers. Ending (or discontinuing) the first metal sheet at a first distance from the laminate edge, and/or the second metal sheet at a second distance from the laminate edge, and/or the adhesive layer at a third distance from the edge, whereby, in an embodiment at least two of the first, second and third distances differ from each other, yields a laminate thickness that is gradually (or step-wise) reduced towards the laminate edge.

A useful embodiment of the invention relates to a laminate wherein the third distance is equal to the first and/or second distance. In this embodiment, the adhesive layer between the first and second metal sheet ends together (at the same distance from the edge) as the first and/or second metal layer. In another embodiment in which the third distance differs from the first and/or second distance, the adhesive layer will extend further than (beyond the end of) the first and/or second layer.

Improvements in mechanical behavior may be obtained in an embodiment of the laminate wherein the third distance differs from the first distance by an amount of at least 5 times the thickness of the first metal sheet. In a preferred embodiment where the third distance is smaller than the first distance, the adhesive layer then extends further than the first sheet over an amount of at least 5 times the thickness of the first metal sheet in the direction of the edge of the laminate.

Yet another embodiment provides a laminate wherein the thickness of the first metal sheet is reduced in the edge area and the edge area extends over a distance from the edge of at least 10 times the thickness tₘₑₜₐₗ of the first metal sheet, preferably at least 20 times the thickness tₘₑₜₐₗ of the first metal sheet, most preferably at least 50 times the thickness tₘₑₜₐₗ of the first metal sheet and at most 200 times said thickness, which thickness tₘₑₜₐₗ corresponds to the unreduced thickness of the first metal sheet. Reduction of the thickness of the first metal sheet in the edge area may be continuous to obtain a gradual variation in thickness (providing a tapering thickness), or may be instantaneous (providing a sudden step in thickness), and is conveniently performed by milling away some material of the first metal sheet in the thickness direction.

A (fiber-metal) laminate according to the invention is particularly useful in providing a fatigue resistant structure, such as an aerospace structure.

A particularly preferred (fiber-metal) laminate according to some embodiments comprises a fuselage structure, a tail plane structure, or a wing structure. A (fiber-metal) laminate according to the invention may in some embodiments be combined and connected to a further structural element such as a stiffener, angle section, Z-stringer, hat stringer, C-stringer, Y-stringer; a spar(section), rib(section), shear-cleat and/or frame(section) of an aircraft structure. The further structural element may be connected to the laminate by a bonding layer, comprising an adhesive and/or a fiber-reinforced adhesive, or may be connected by mechanical fastening means. A combination of both ways of connecting is also possible.

### BRIEF DESCRIPTION OF THE FIGURES

FIG. 1—is a view in perspective of a fiber-metal laminate according to an embodiment of the present invention;

FIG. 2—is a view in perspective of a fiber-metal laminate according to another embodiment of the present invention;

FIGS. 3-10—are perspective views of other embodiments of a fiber-metal laminate according to the invention having a reduced laminate thickness in an edge area of the laminate; and

FIGS. 11-13—are cross-sectional views of other embodiments of a fiber-metal laminate according to the invention.

### DETAILED DESCRIPTION OF THE INVENTION

In the following description, reference is made to the accompanying drawings, which form a part hereof, and which show, by way of illustration, specific embodiments in which the invention may be practiced. The present invention, however, may be practiced without the specific details or with certain alternative equivalent methods to those described herein.

The basis of the present invention is a unique arrangement of at least one metal sheet and an adhesive layer adhered thereto. The adhesive layer is preferred embodiments comprise reinforcement fibers. In accordance with certain embodiments, a fiber-metal laminate is provided comprising fiber-reinforced composite layers and metal sheets, wherein a fiber-reinforced composite layer and an adjacent first metal sheet have related properties in a specific manner, as given by relation (1). The fiber-reinforced composite layers preferably comprise fibers pre-impregnated with a composite matrix system, preferably a metal adhesive (prepreg). The system of composite layers and metal sheets is preferably processed under heat and pressure to cure the adhesive and form a solid panel or component.

It has been discovered by the inventor that laminates with metal sheet and adhesive layer properties according to equation (1) have better structural properties in fatigue, in particular a higher resistance against crack growth than fiber-metal laminates of which the relevant properties are not in accordance with relation (1). The parameters used in equation (1) are well known to the person skilled in the art and this person will have no difficulty in determining the properties mentioned. The invention is based on the insight that the extensional stiffness of a metal sheet and an adjacent adhesive layer (preferably fiber-reinforced composite layer) are related in view of obtaining a high crack growth resistance.

The fiber-reinforced composite layers in the fiber-metal laminates according to the invention are light and strong and comprise reinforcing fibers embedded in a polymer. The polymer typically acts as a bonding means between the various layers. Reinforcing fibers that are suitable for use in the fiber-reinforced composite layers depend on the choice of metal in the metal sheets (see equation (1)) but may include glass fibers, aramid fibers, PBO fibers, carbon fibers, copolymer fibres, boron fibres and metal fibers and/or combinations of the above fibers.

Examples of suitable matrix materials for the reinforcing fibers include but are not limited to thermoplastic polymers such as polyamides, polyimides, polyethersulphones, polyetheretherketone, polyurethanes, polyphenylene sulphides (PPS), polyamide-imides, polycarbonate, polyphenylene oxide blend (PPO), as well as mixtures and copolymers of one or more of the above polymers. Suitable matrix materials also comprise thermosetting polymers such as epoxies, unsaturated polyester resins, melamine/formaldehyde resins, phenol/formaldehyde resins, polyurethanes, of which thermosetting polymers epoxies are most preferred.

In the laminate according to the invention, the fiber-reinforced composite layer preferably comprises substantially continuous fibers that extend in multiple direction (like 0°, 90° and angles with respect to 0°) and more preferable in two almost orthogonal directions (for instance isotropic woven fabrics or cross plies). However it is even more preferable for the fiber-reinforced composite layer to comprise substantially continuous fibers that mainly extend in one direction (so called UD material). It is advantageous to use the fiber-reinforced composite layer in the form of a pre-impregnated semi-finished product. Such a “prepreg” shows generally good mechanical properties after curing thereof, among other reasons because the fibers have already been wetted in advance by the matrix polymer.

In some embodiments of the invention, fiber-metal laminates may be obtained by connecting a number of metal sheets and fiber-reinforced composite layers to each other by means of heating under pressure and subsequent cooling. The fiber-metal laminates of the invention have good specific mechanical properties (properties per unit of density). Metals that are particularly appropriate to use include steel (alloys) and light metals, such as aluminum alloys and in particular titanium alloys. Suitable aluminum alloys are based on alloying elements such as copper, zinc, magnesium, silicon, manganese, and lithium. Small quantities of chromium, titanium, scandium, zirconium, lead, bismuth and nickel may also be added, as well as iron. Suitable aluminum alloys include aluminum copper alloys (2xxx series), aluminum magnesium alloys (5xxx series), aluminum silicon magnesium alloys (6xxx series), aluminum zinc magnesium alloys (7xxx series), aluminum lithium alloys (2xxx, 8xxx series), as well as aluminum magnesium scandium alloys. Suitable titanium alloys include but are not limited to alloys comprising Ti-15V-3Cr-3Al-3Sn, Ti-15Mo-3Al-3Nb, Ti-3Al-8V-6Cr-4Zr-4Mo, Ti-13V-11Cr-3Al, Ti-6Al-4V and Ti-6Al-4V-2Sn. In other respects, the invention is not restricted to laminates using these metals, so that if desired other metals, for example steel or another suitable structural metal can be used. The laminate of the invention may also comprise metal sheets of different alloys.

A fiber-metal laminate according to some embodiments of the invention may be formed by combining a number of metal sheets and a number of fiber-reinforced composite layers, with the proviso that the extensional stiffness of a metal sheet and an adjacent adhesive layer satisfies equation (1).

The outer layers of the fiber-metal laminate may comprise metal sheets and/or fiber-reinforced composite layers. The number of metal layers may be varied over a large range and is at least one. In a particularly preferred fiber-metal laminate, the number of metal layers is two, three or four, between each of which fiber-reinforced composite layers have preferably been applied. Depending on the intended use and requirements set, the optimum number of metal sheets can easily be determined by the person skilled in the art. The total number of metal sheets will generally not exceed 50, although the invention is not restricted to laminates with a maximum number of metal layers such as this. According to the invention, the number of metal sheets is preferably between 1 and 40, and more preferably between 1 and 25.

To prevent the laminate from warping as a result of internal tensions, the laminate according to the invention can be structured symmetrically with respect to a plane through the center of the thickness of the laminate.

Fiber-metal laminate configurations according to some embodiments of the invention are readily obtained by arranging (alternating) layers of fiber-reinforced composite, preferably in the form of prepregs, and at least one metal sheet. The fiber-metal laminates can be designed in many different arrangements.

With reference to FIG. 1, a fiber-metal laminate according to one embodiment is shown, wherein the total number of layers is 3, and wherein layer 1 and layer 3 comprise a metal sheet and layer 2 a fibrous composite layer. Alternatively, layer 1 and layer 3 comprise a fibrous composite layer and layer 2 is a metal sheet. Layer 1 and layer 3 can comprise the same metal alloy or may be made of a different kind of metal alloy. The fibrous composite layer(s) may contain fibers in multiple directions as well as different kind of fibers. At least one of the combinations of layers 1 and 2, or 2 and 3, fulfills the requirement set in equation (1).

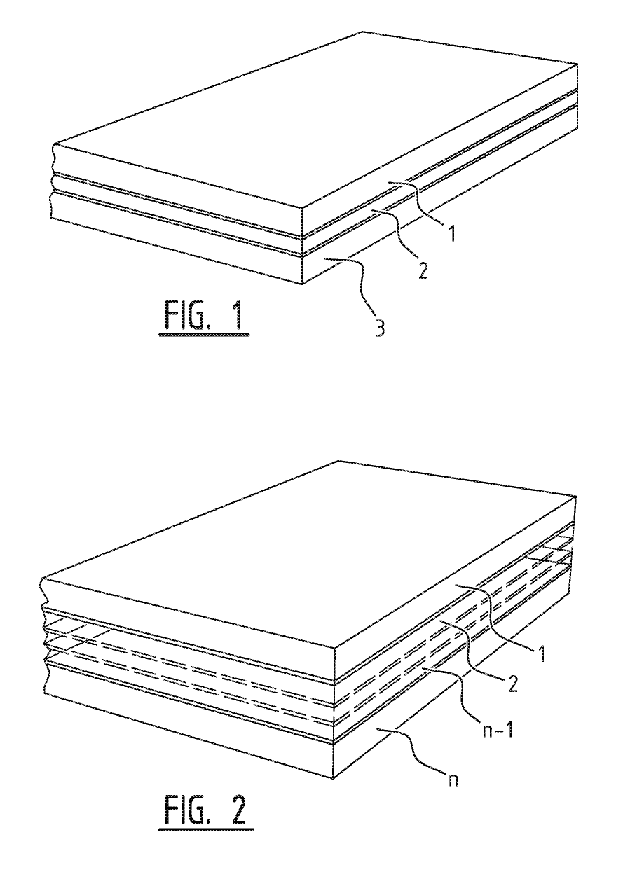

With reference to FIG. 2, a fiber-metal laminate according to another embodiment is shown, wherein the total number of layers is n, and wherein layer 1 is a metal sheet and layer 2 is a fibrous composite layer, which will be alternating until layer n-1 and layer n. Alternatively, layer 1 is a fibrous composite layer and layer 2 is a metal sheet, which will be alternating until layer n-1 and layer n. The alternating metal sheets can be made of the same metal alloy or be made from a different kind of metal alloy, and may have different thicknesses. Also, at least one of the alternating fibrous composite layers may contain fibers in multiple directions as well as different kind of fibers. According to the invention, at least one combination of a fiber-reinforced composite layer (for instance layer 2) and an adjacent metal sheet (for instance layer 1 or 3) needs to satisfy relation (1). In case metal sheets (1) and (3) differ in thickness, the thickest metal sheet is selected as first metal sheet in the combination. In case the outer layer of the laminate is a fibrous composite layer, this layer preferably needs to fulfill the requirements set in equation (1) with respect to its adjacent metal sheet, unless another metal sheet with its adjacent fiber composite layer already fulfills the requirements of equation (1). If the outer layer is a metal sheet, it preferably needs to fulfill the requirements set in equation (1) with respect to its adjacent fibrous composite layer, unless another metal sheet with its adjacent fibrous composite layer already fulfills the requirements of equation (1).

The laminates are produced by preparing a stack of fibrous composite and metal sheets in the sequence as exemplified in FIGS. 1 and 2, for example on a flat or single, double or multiple curved mold. After lamination, the overall structure is cured at a temperature suitable for the matrix resin, preferably an epoxy resin, for instance in an autoclave, and preferably under vacuum in order to expel entrapped air from the laminate. For most applications, an epoxy resin with a high glass transition temperature will be most suitable. Any epoxy resin may be used however. Epoxy resins are generally cured at or slightly above room temperature, at a temperature of approximately 125° C. or at a temperature of approximately 175° C. After curing under pressure a consolidated laminate is obtained. As mentioned above, it is also possible to use a thermoplastic resin.

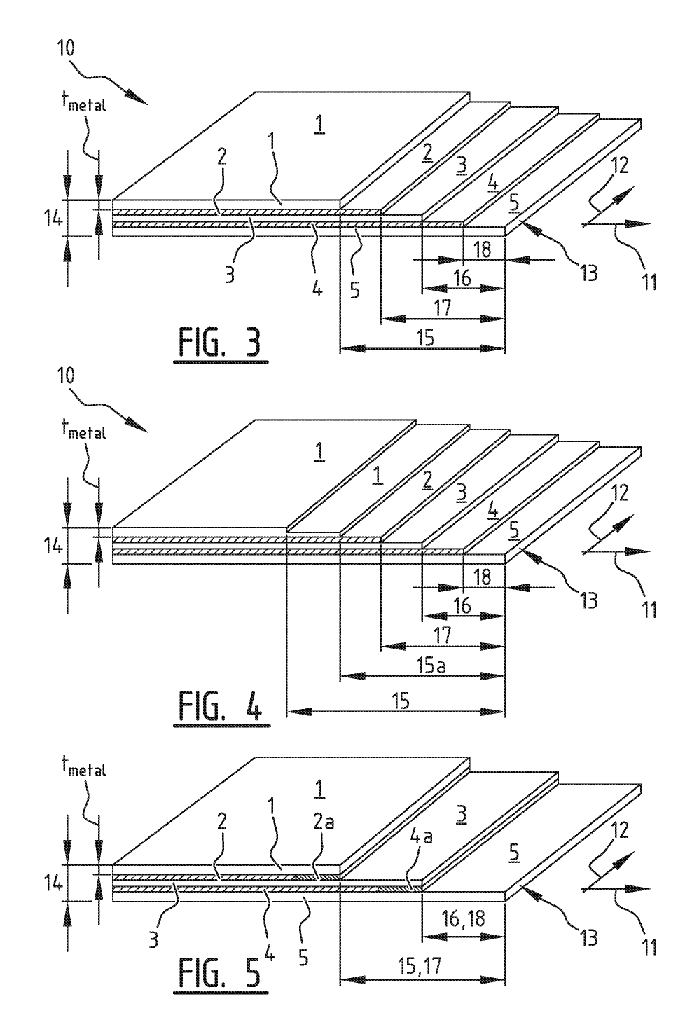

FIG. 3 shows another embodiment of a laminate in accordance with the invention. The laminate 10 comprises 5 layers in total. Laminate 10 in particular comprises an aluminum sheet 1 with a thickness tₘₑₜₐₗ of 1.2 mm, a high strength glass fiber epoxy composite layer 2 bonded to the first aluminum sheet 1, a second aluminum sheet 3 with a thickness of 0.6 mm (smaller than tₘₑₜₐₗ) and bonded to composite layer 2, another high strength glass fiber epoxy composite layer 4 bonded to the second aluminum sheet 3, and another aluminum sheet 5 bonded to composite layer 4 and having a thickness of 1.2 mm. The composite layer 2 has about 45 vol % of glass fibers running in a length direction 11 of the laminate. The fibers have a Young's modulus of about 85 GPa. The thickness of layer 2 is about 0.2 mm. The extensional stiffness E*t of layer 1 is about 72 GPa*1.2 mm, whereas the extensional stiffness of layer 2 is about 0.45*85 GPa*0.2 mm. Equation (1) then yields a value of about 11.3 which is within the claimed range.

Laminate 10 further has an edge 13 and the total thickness 14 of the laminate 10 is reduced in an edge area of laminate 10 towards the edge 13. The thickness reduction is achieved by ending the first aluminum sheet 1 at a first distance 15 from the laminate edge 13, optionally ending another aluminum sheet 3 at a second distance 16 from the laminate edge 13, and ending the adhesive layer 2 adjacent to the first metal sheet 1 at a third distance 17 from the edge 13. The distance 15 in the present embodiment corresponds to the distance over which the edge area extends from edge 13. Another adhesive layer 4 is ended at yet another distance 18 from the edge 13. The distances 15 to 18 all differ from each other, in fact these distances decrease from distance 15 to distance 18 to achieve a tapered laminate in the edge area.

FIG. 4 shows another embodiment of a laminate in accordance with the invention. The laminate 10 comprises the same 5 layers as those of the embodiment of FIG. 3. However, the first aluminum sheet 1 has a variable thickness, which in the embodiment shown varies from a constant thickness of 1.2 mm to a constant thickness of 0.6 mm in a stepwise fashion. The largest thickness of the first aluminum sheet (1.2 mm) is taken as tₘₑₜₐₗ in relation (1).

Laminate 10 further has an edge 13 and the total thickness 14 of the laminate 10 is reduced in an edge area 15 of laminate 10 towards the edge 13. The thickness reduction is achieved by reducing the thickness of the first aluminum sheet 1 at a first distance 15 from the laminate edge 13 (which is the same as ending part of the first aluminum sheet 1), ending the first aluminum sheet 1 at a distance 15a from the laminate edge 13, optionally ending another aluminum sheet 3 at a second distance 16 from the laminate edge 13, and by ending the adhesive layer 2 adjacent the first metal sheet 1 at a third distance 17 from the edge 13. Another adhesive layer 4 is ended at another distance 18 from the edge 13. The distances 15, 15a to 18 all differ from each other, in fact these distances decrease from distance 15 to distance 18.

FIG. 5 shows yet another embodiment in accordance with the invention. The laminate 10 comprises the same 5 layers as those of the embodiment of FIGS. 3 and 4. Laminate 10 again has an edge 13 and the total thickness 14 of the laminate 10 is reduced in an edge area 15 of laminate 10 towards the edge 13. The thickness reduction is achieved by ending the first aluminum sheet 1 at a distance 15 from the laminate edge 13, optionally ending another aluminum sheet 3 at a second distance 16 from the laminate edge 13. The adhesive layer 2 adjacent the first metal sheet 1 is ended at a third distance 17 from the edge 13, which distance 17 in the present embodiment is equal to the first distance 15. Another adhesive layer 4 is ended at a distance 18 from the edge 13 which is equal to distance 16. Adhesive fiber-composite layers 2 and 4 have fibers running in the length direction 11 but are void of reinforcing fibers at extreme ends (2a, 4a).

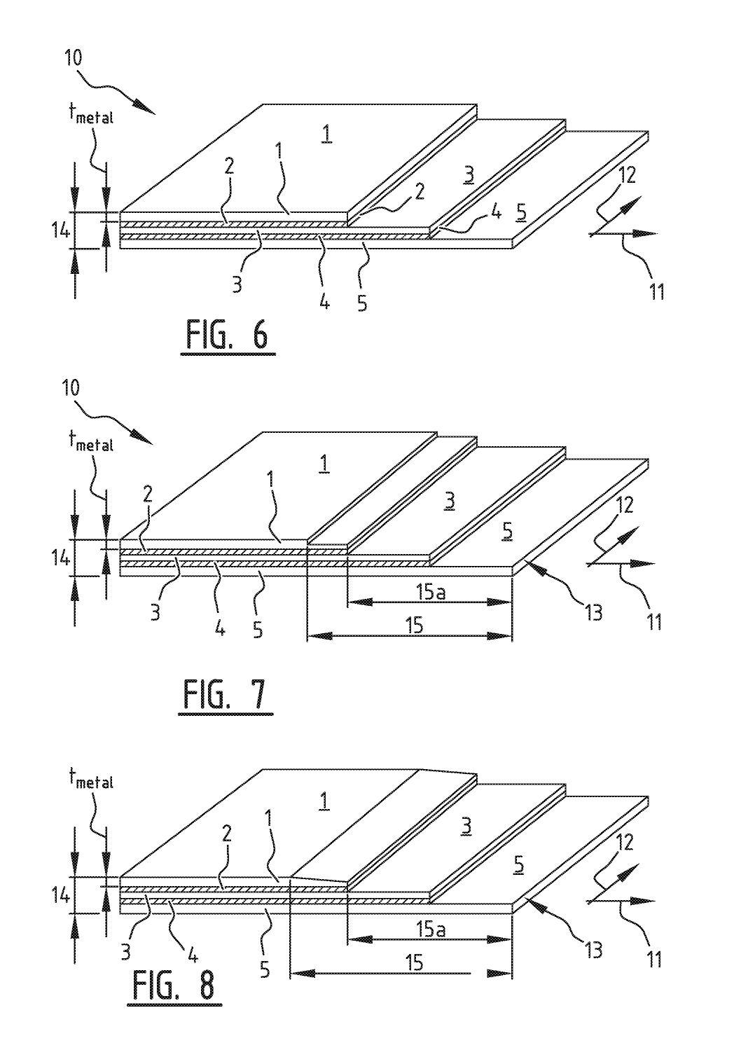

FIG. 6 shows yet another embodiment of a laminate in accordance with the invention. The laminate 10 comprises 5 layers in total. Laminate 10 in particular comprises an aluminum sheet 1 with a thickness tₘₑₜₐₗ of 1.0 mm, a high strength glass fiber epoxy composite layer 2 bonded to the first aluminum sheet 1, a second aluminum sheet 3 with a thickness of 0.5 mm (smaller than tₘₑₜₐₗ) and bonded to composite layer 2, another high strength glass fiber epoxy composite layer 4 bonded to the second aluminum sheet 3, and another aluminum sheet 5 bonded to composite layer 4 and having a thickness of 1.5 mm. The composite layer 2 has about 55 vol % of glass fibers running in a length direction 11 of the laminate. The fibers have a Young's modulus of about 85 GPa. The thickness of layer 2 is about 0.25 mm. The extensional stiffness E*t of layer 1 is about 72 GPa*1.0 mm, whereas the extensional stiffness of layer 2 is about 0.55*85 GPa*0.25 mm. Equation (1) then yields a value of about 6 which is within the claimed range.

In FIG. 7 another embodiment of a laminate in accordance with the invention is shown. The laminate of FIG. 7 differs from the laminate of FIG. 6 in that the outer aluminum sheet 1 has a reduced thickness in an edge area towards the edge 13 of aluminum sheet 1 over a distance 15. The thickness reduction is achieved by reducing the thickness of the first aluminum sheet 1 at a first distance 15 from the laminate edge 13 (which is the same as ending part of the first aluminum sheet 1), and ending the first aluminum sheet 1 at a distance 15a from the laminate edge 13, the distance 15a being smaller than the thickness 15.

FIG. 8 shows another embodiment of a laminate in accordance with the invention. The laminate of FIG. 8 is largely the same as that of FIG. 7 with the exception that the thickness reduction of aluminum sheet 1 is gradual (or tapered) from a distance 15 of the edge 13 to a distance 15a from the edge 13.

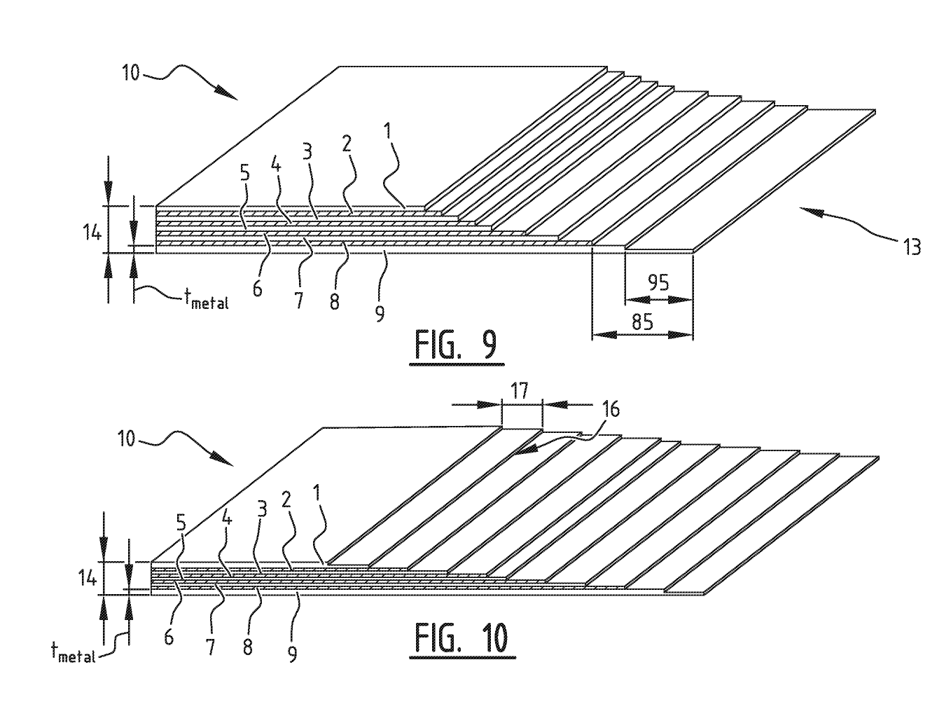

FIG. 9 shows yet another embodiment of a laminate in accordance with the invention. The laminate 10 comprises 9 layers in total. Laminate 10 in particular comprises an aluminum sheet 9 with a thickness tₘₑₜₐₗ of 3.0 mm, a high strength glass fiber epoxy composite layer 8 bonded to the first aluminum sheet 9, a second aluminum sheet 7 with a thickness of 0.4 mm (smaller than tₘₑₜₐₗ) and bonded to composite layer 8, another high strength glass fiber epoxy composite layer 6 bonded to the aluminum sheet 7, and another aluminum sheet 5 bonded to composite layer 6 and having a thickness of 0.4 mm, another high strength glass fiber epoxy composite layer 4 bonded to the aluminum sheet 5, and another aluminum sheet 3 bonded to composite layer 4 and having a thickness of 0.4 mm, another high strength glass fiber epoxy composite layer 2 bonded to the aluminum sheet 3, and another aluminum sheet 1 bonded to composite layer 2 and having a thickness of 0.4 mm. The outer aluminum sheet 9 can have a constant thickness, a tapered thickness or, as shown in FIG. 9 a thickness reduction. The thickness reduction is achieved by reducing the thickness of metal sheet 9 at a distance 95 from the edge 13. Composite layer 8 ends at a distance 85 which is larger than distance 95. The composite layer 8 has about 55 vol % of glass fibers running in a length direction 11 of the laminate. The fibers have a Young's modulus of about 90 GPa. The thickness of layer 8 is about 0.4 mm. The extensional stiffness E*t of layer 9 is about 72 GPa*3.0 mm, whereas the extensional stiffness of layer 8 is about 0.55*90 GPa*0.40 mm. Equation (1) then yields a value of about 11 which is within the claimed range.

FIG. 10 shows another embodiment of a laminate in accordance with the invention. The laminate 10 comprises 9 layers in total. It is largely equivalent to the laminate of FIG. 9 with the exception that aluminum sheet 1 has a thickness of 2.0 mm instead of 0.4 mm and that sheet 1 has a reduced thickness towards the edge 16 of aluminum sheet 1 over a distance 17.

FIGS. 11-13 finally represent cross-sections of three other embodiments of a laminate in accordance with the invention. The laminate 10 of FIG. 11 comprises an alternating stack of relatively thick metal sheets (1, 5, 9, 23) and relatively thin metal sheets (3, 7, 21). The metal sheets (1, 3, 5, 7, 9, 21, 23) are mutually bonded by intermittent fiber composite layers (2, 4, 6, 8, 20, 22). At an edge area of the laminate 10, the metal sheets and fiber composite layers end at different distances from the edge 13, so as to produce a tapered part of the laminate 10 at the edge area.

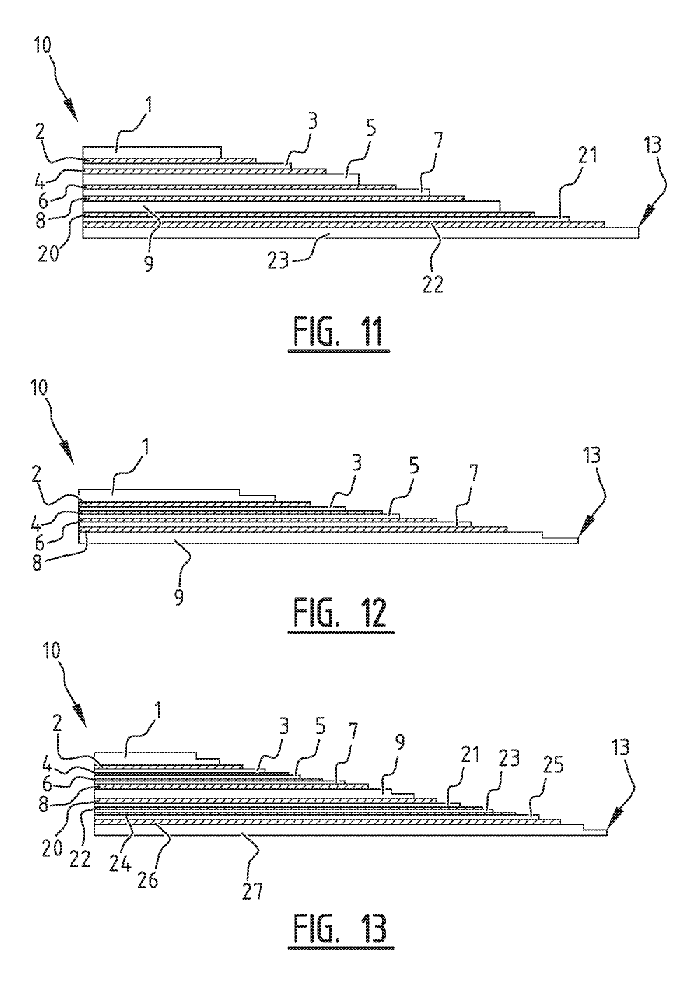

The laminate 10 of FIG. 12 has two relatively thick metal sheets (1, 9) as outer layers in the stack, and a number of 3 relatively thin metal sheets (3, 5, 7) in between the outer metal sheets (1, 9). The metal sheets (1, 3, 5, 7, 9) are mutually bonded by intermittent fiber composite layers (2, 4, 6, 8), of which layers (4, 6) have a smaller thickness than layers (2, 8). At an edge area of the laminate 10, the metal sheets and fiber composite layers end at different distances from the edge 13, so as to produce a tapered part of the laminate 10 at the edge area. Further, metal sheets 1 and 9 have a reduced thickness towards their edge.

The laminate 10 of FIG. 13 finally combines two laminates 10 according to FIG. 12. The laminate has 9 metal sheets and 8 fiber composite layers (2, 4, 6, 8, 20, 22, 24, 26) in total. Metal sheets (1, 9 and 27) are thicker than metal sheets (3, 5, 7, 21, 23, and 25) in accordance with the invention. The thickness of the relatively thick metal sheets (1, 9, 27) is again reduced at their respective edges.

### Experiments

Four different laminate configurations were tested in fatigue. In particular, fatigue crack growth was measured at a maximum stress level of 120 MPa and at a ratio R=0.1; whereby R is the ratio between the minimum stress level and the maximum stress level.

All four tested configurations are so-called GLARE 2 laminates in a 3/2 lay-up. GLARE 2 uses fiber reinforced adhesive layers in the form of prepregs having all fibers extending in one direction parallel to each other. The direction of the fibers is parallel to a rolling direction of the metal sheets used in the laminates and also parallel to the loading direction in the fatigue tests. The metal applied in the metal sheets comprises aluminum alloy 2024-T3 with a tensile modulus E=72.4 GPa. The prepregs applied comprise S2-glass fibers embedded in an epoxy matrix system. The nominal fiber volume content of the prepreg is 19.8% in configurations 1 and 2, and 35.0% in configurations 3 and 4. The respective thickness after curing is 0.38 mm (configurations 1 and 2) and 0.65 mm (configurations 3 and 4)).

Configuration 1 is a laminate which consists of three metal layers of a thickness of 2.0 mm and one prepreg layer, placed in between each metal layer. This laminate is referred to as GLARE 2-3/2-2.0-1 pp. Configuration 2 is a laminate which consists of three metal layers of a thickness of 2.0 mm and three prepreg layers, placed in between each metal layer. This laminate is called GLARE 2-3/2-2.0-3 pp. Configuration 3 is a laminate which consists of three metal layers of a thickness of 1.3 mm and one prepreg layer, placed in between each metal layer. This laminate is called GLARE 2-3/2-1.3-1 pp. Configuration 4 finally is a laminate which consists of three metal layers of a thickness of 1.3 mm and three prepreg layers, placed in between each metal layer. This laminate is called GLARE 2-3/2-1.3-3 pp.

The S2-glass fiber applied in the prepregs has an E-modulus of 88 GPa and the applied epoxy system has an E-modulus of 2.2 GPa. The stiffness ratio according to equation (1) of claim 1 can be determined for the different configurations as shown in Table A.

TABLE A

| | | Fibre | (Eₘₑₜₐₗ*tₘₑₜₐₗ)/ |
|---|---|---|---|
| Configuration | | Volume | (E_{adh}*t_{adh}) |
| 1 | GLARE 2-3/2-2.0-1 pp | 19.8% | 19.7 |
| 2 | GLARE 2-3/2-2.0-3 pp | 35.0% | 6.9 |
| 3 | GLARE 2-3/2-1.3-1 pp | 19.8% | 12.8 |
| 4 | GLARE 2-3/2-1.3-3 pp | 35.0% | 4.5 |

Table A clearly shows that configuration 1 is outside the range of eq. (1). Configuration 3 on the other hand has a stiffness ratio of 12.8 which is relatively close to the upper border value of eq. (1).

Figure B shows the obtained results in terms of crack growth data ‘da/dn’, where ‘n’ denotes the number of fatigue cycles, versus the half crack length ‘a’. Results are shown for configurations 1-4 and for a sheet of monolithic aluminum alloy 2024-T3. It may be inferred from Figure B that the crack growth rate of the monolithic aluminum alloy is highest and shows failure of the specimen at a half crack length a=21 mm. The specimen outside the range of eq. (1) with configuration 1 has failed like the aluminum specimen at a half crack length a=26 mm and further appears to have a slope of the crack growth rate in the same range as the slope of the crack growth rate of the aluminum alloy.

While the aluminum alloy and laminate according to configuration 1 failed at a relatively small crack length, the other configurations 2-4 which are according to the invention could be loaded without failure to much higher half crack lengths.

The configurations 2-4 further all show significantly smaller crack growth rates with configuration 4 showing the best performance. This configuration has the lowest stiffness ratio (Eq. (1)).

1.-22. (canceled)

23. A laminate comprising a first metal sheet and an adhesive layer bonded to the first metal sheet, wherein the following relation applies:
3.5≦(Eₘₑₜₐₗ*tₘₑₜₐₗ)/(E_{adh}*t_{adh})≦15 (1)
wherein
Eₘₑₜₐₗ=tensile Young's modulus of the first metal sheet,
tₘₑₜₐₗ=thickness of the first metal sheet,
E_{adh}=tensile Young's modulus of the adhesive layer, and
t_{adh}=thickness of the adhesive layer;
wherein the laminate comprises a second metal sheet bonded to the adhesive layer and having a thickness ≦tₘₑₜₐₗ.

24. The laminate according to claim 23, wherein the first metal sheet has a thickness tₘₑₜₐₗ of larger than 0.5 mm.

25. The laminate according to claim 23, wherein: 4.25≦(Eₘₑₜₐₗ*tₘₑₜₐₗ)/(E_{adh}*t_{adh})≦13.5.

26. The laminate according to claim 23, wherein the adhesive layer comprises reinforcing fibers to form a fiber-metal laminate, and
E_{adh}=tensile Young's modulus of the fiber reinforced adhesive layer in a direction of maximum stiffness, and
t_{adh}=thickness of the fiber reinforced adhesive layer.

27. The laminate according to claim 23, comprising N metal sheets having a thickness equal to tₘₑₜₐₗ, and M metal sheets having a thickness ≦tₘₑₜₐₗ, wherein N ≧2 and M ≧1.

28. The laminate according to claim 23, comprising P second metal sheets directly bonded to a first metal sheet, wherein P ≧1.

29. The laminate according to claim 23, wherein the thickness of the second metal sheet is less than 0.8 mm.

30. The laminate according to claim 23, wherein the first and/or other metal sheets have a variable thickness, and the thickness tₘₑₜₐₗ of the first metal sheet in relation corresponds to the largest thickness of the first metal sheet, whereby the area of largest thickness extends over more than 80% of the laminate's area.

31. The laminate according to claim 23, comprising metal sheets of different metal alloys.

32. The laminate according to claim 23, comprising metal sheets of an aluminum alloy.

33. The laminate according to claim 26, comprising a fiber-reinforced adhesive layer with at least two different fibers, and/or comprising fiber-reinforced adhesive layers that differ in fiber.

34. The laminate according to claim 26, wherein a fiber-reinforced adhesive layer comprises high strength glass fibers having a tensile Young's modulus of at least 80 GPa.

35. The laminate according to claim 23, comprising two first metal sheets that are connected to each other by a number of second metal sheets and intermittent adhesive layers.

36. A process for providing a fatigue resistant structure comprising providing a laminate according to claim 23.

37. An aerospace structure comprising a laminate according to claim 23.

38. The aerospace structure according to claim 37, comprising a fuselage structure, a tail plane structure, or a wing structure.

39. The laminate according to claim 32, comprising at least one aluminum lithium sheet.
